(19) United States
(12) Patent Application Publication
(10) Pub. No.: US 2013/0333240 A1
(43) Pub. Date: Dec. 19, 2013

(54) STEAM DRIER

(71) Applicant: Shaolong Chen, Riihimaki (FI)

(72) Inventor: Shaolong Chen, Riihimaki (FI)

(73) Assignee: Kumera Oy, Riihimaki (FI)

(21) Appl. No.: 14/001,987

(22) PCT Filed: Mar. 4, 2011
(86) PCT No.: PCT/FI11/50192

§ 371 Date: Aug. 28, 2013

(51) Int. Cl. F26B 23/06

(52) U.S. Cl. CPC F26B 23/06
USPC 34/604

(57) ABSTRACT

A steam drier including a rotatable elongated drum (1) and a set of heating elements (2) provided in the interior space within the drum and supported on the drum in order to rotate along with it. Each heating element (2) includes a pair of straight first longitudinal pipes (3, 4) supported in parallel to each other at a distance (A) from each other. The first longitudinal pipes extend in the longitudinal direction of the drum. A pair of end pipes (5, 6) extends substantially transversely relative to the first longitudinal pipes in the vicinity of the ends of the first longitudinal pipes. The end pipes connect the first longitudinal pipes rigidly to each other. The first longitudinal pipes are provided in flow connection to each other through the end pipes in order to allow the flow of steam within the heating element. The heating element (2) includes a set of straight second longitudinal pipes (7) provided in parallel to the first longitudinal pipes (3, 4). The second longitudinal pipes are fastened by each end to the end pipes (5, 6) so that each two adjacent second longitudinal pipes are disposed at a distance (B) from each other. The second longitudinal pipes (7) are provided in flow connection with the end pipes (5, 6).

### FIELD OF THE INVENTION

The invention relates to the steam drier defined in the preamble of claim 1.

### BACKGROUND OF THE INVENTION

Known from publication U.S. Pat. No. 6,415,527 is a steam drier commonly used especially for continuous drying of ore concentrate, i.e. to remove water, before feeding the concentrate into a smelting furnace. The steam drier includes a rotatable elongated cylindrical drum. Provided in the interior space within the drum is a set of heating elements supported on the drum to rotate along with it. Each heating element is formed as a self-supporting structure, being detachable and replaceable as one assembly. Each heating element has its own steam circulation separate from the steam circulation of the other heating elements. The formation of a steam line from separate heating elements, each with its own steam circulation, is advantageous because, if a leak appears within the element, the feed of steam to the defective element can be disconnected and, at the same time, the steam drying can be continued without interruption at a bit lower drying capacity. When one wishes to change the heating element, it can be detached as an individual assembly and quickly replaced with a functioning element.

Each heating element includes a pair of straight first longitudinal pipes supported in parallel to each other at a distance from each other. The first longitudinal pipes extend in the longitudinal direction of the drum. Furthermore, the heating element includes a pair of curved end pipes extending substantially transversely relative to the first longitudinal pipes in the vicinity of the ends of the first longitudinal pipes. The end pipes connect the first longitudinal pipes rigidly to each other so that the first longitudinal pipes are provided in flow connection to each other through the end pipes in order to allow the flow of steam within the heating element.

In addition to the end pipes that extend between the ends of the heating element, the known heating element includes transversal curved intermediate pipes provided along the length of the heating element at a distance from each other to extend between the first longitudinal pipes. The curvature of the intermediate pipes corresponds to the curvature of the end pipes. The intermediate pipes and the first longitudinal pipes are fastened to each other so that a flow connection is provided between them in order to allow the flow of steam. The intermediate pipes are transverse because, from the wear resistance standpoint, the intention has been that they should be parallel to the movement of the material to be dried and the material would not resist rotation of the element.

A problem in the known structure of the heating element is the very large number of weld connection lines, which makes the manufacturing costs higher. The large number of curved intermediate pipes also causes additional costs because each intermediate pipe must be bent to a suitable curvature. A number of apertures that corresponds to the large number of intermediate pipes must correspondingly be provided on the longitudinal pipes in order to enable the flow connection.

### OBJECTIVE OF THE INVENTION

An objective of the invention is to eliminate the drawbacks referred to above.

Especially, an objective of the invention is to disclose a steam drier wherein the manufacturing costs of the heating elements are substantially lower than before.

### SUMMARY OF THE INVENTION

The steam drier according to the invention is characterized by what has been presented in claim 1.

The steam drier according to the invention includes a rotatable elongated drum and a set of heating elements provided in the interior space within the drum and supported on the drum in order to rotate along with the drum. Each heating element includes a pair of straight first longitudinal pipes supported in parallel to each other at a distance from each other. The first longitudinal pipes extend in the longitudinal direction of the drum. Furthermore, the heating element includes a pair of end pipes extending substantially transversely relative to the first longitudinal pipes in the vicinity of the ends of the first longitudinal pipes. The end pipes connect the first longitudinal pipes rigidly to each other. The first longitudinal pipes are provided in flow connection to each other through the end pipes in order to allow the flow of steam within the heating element.

According to the invention the heating element includes a set of straight second longitudinal pipes provided in parallel to the first longitudinal pipes, the second longitudinal pipes being fastened to the end pipes by each end so that each two adjacent second longitudinal pipes are disposed at a distance from each other and the second longitudinal pipes are provided in flow connection with the end pipes.

An advantage of the invention is that, compared with the conventional known heating element, the number of weld connections in the heating element according to the invention is substantially smaller. Holes do not have to be made on the first longitudinal pipes except in the area of the end pipes. The second longitudinal pipes are straight so they need not be bent. The manufacture includes fewer work stages than before and the manufacturing costs are cheap.

In one embodiment of the steam drier the heating element includes a set of curved stiffening members arranged to extend transversely relative to the first and the second longitudinal pipes and fastened at a distance from each other along the length of the heating element.

In one embodiment of the steam drier a set of heating elements is provided on a support structure adapted to bind said heating elements to each other to form a self-supporting package.

In one embodiment of the steam drier the heating element includes intermediate pipes in parallel to the end pipes extending substantially transversely relative to the first longitudinal pipes. The intermediate pipes are fastened by the ends to the first longitudinal pipes so that the first longitudinal pipes are provided in flow connection to each other through the intermediate pipes.

In one embodiment of the steam drier the end pipes are curved.

In one embodiment of the steam drier the end pipes are straight.

In one embodiment of the steam drier the end pipes are V-shaped.

### LIST OF FIGURES

In the following the invention will be described in detail with an example embodiment, referring to the accompanying drawing in which

FIG. 1 schematically presents partial cross section of one embodiment of the steam drier according to the invention,

FIG. 2 presents section II-II,

FIG. 3 presents a heating element of a first embodiment of the invention, and

FIG. 4 presents section IV-IV from FIG. 3,

FIG. 5a presents cross section of an embodiment corresponding to FIG. 4 where the end pipes of the heating element are straight,

FIG. 5b presents cross section of an embodiment corresponding to FIG. 4 where the end pipes of the heating element are V-shaped.

FIG. 6 presents an embodiment where heating elements of different sizes are assembled together to form a self-supporting package, and

FIG. 7 presents a heating element of a second embodiment of the invention.

### DETAILED DESCRIPTION OF THE INVENTION

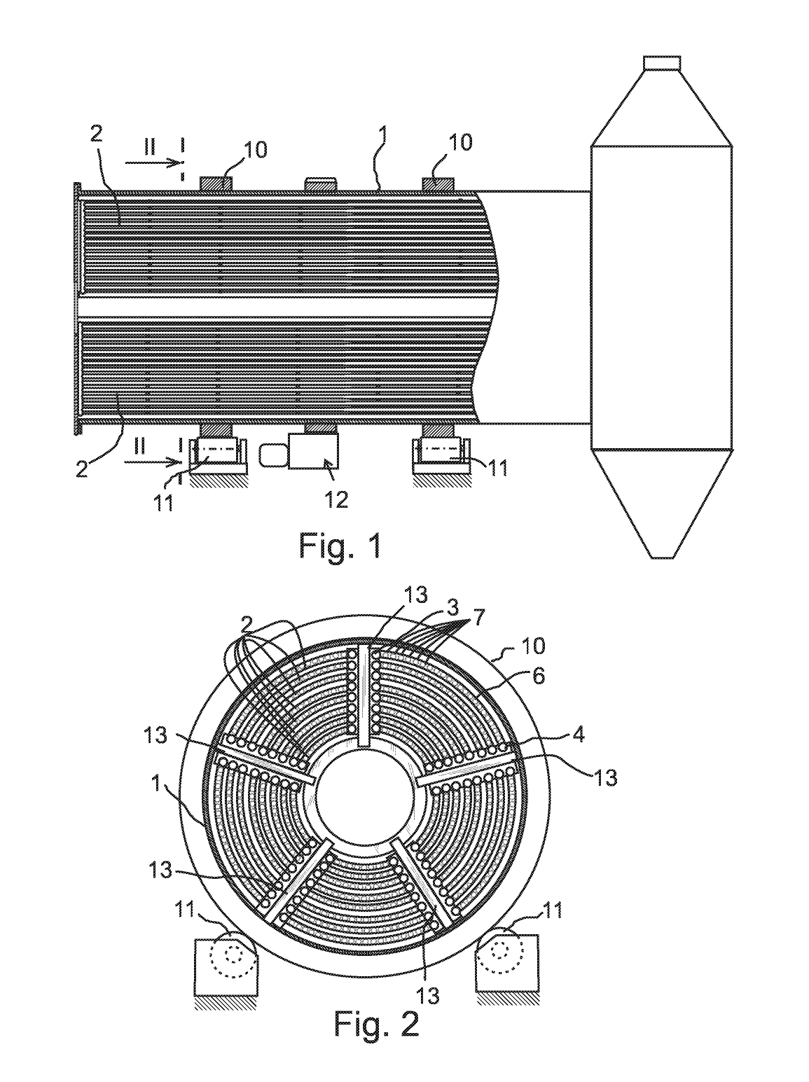

FIG. 1 schematically presents a steam drier. The steam drier includes an elongated cylidrical drum 1. Fastened to the circumference of the drum 1 are two bearer rings 10. The drum 1 lies on rolls 11 supported on the bearer rings 10. The drum 1 is rotated by rotating means 12.

As shown in FIG. 2, provided within the drum 1 is a set of heating elements 2. The heating elements 2 are supported on the drum 1 by braces 13 fastened to the drum 1, so that the heating elements 2 rotate along with the drum 1. The radius of curvature of the curved heating elements 2 increases in moving from the center of the drum 1 toward the circumference.

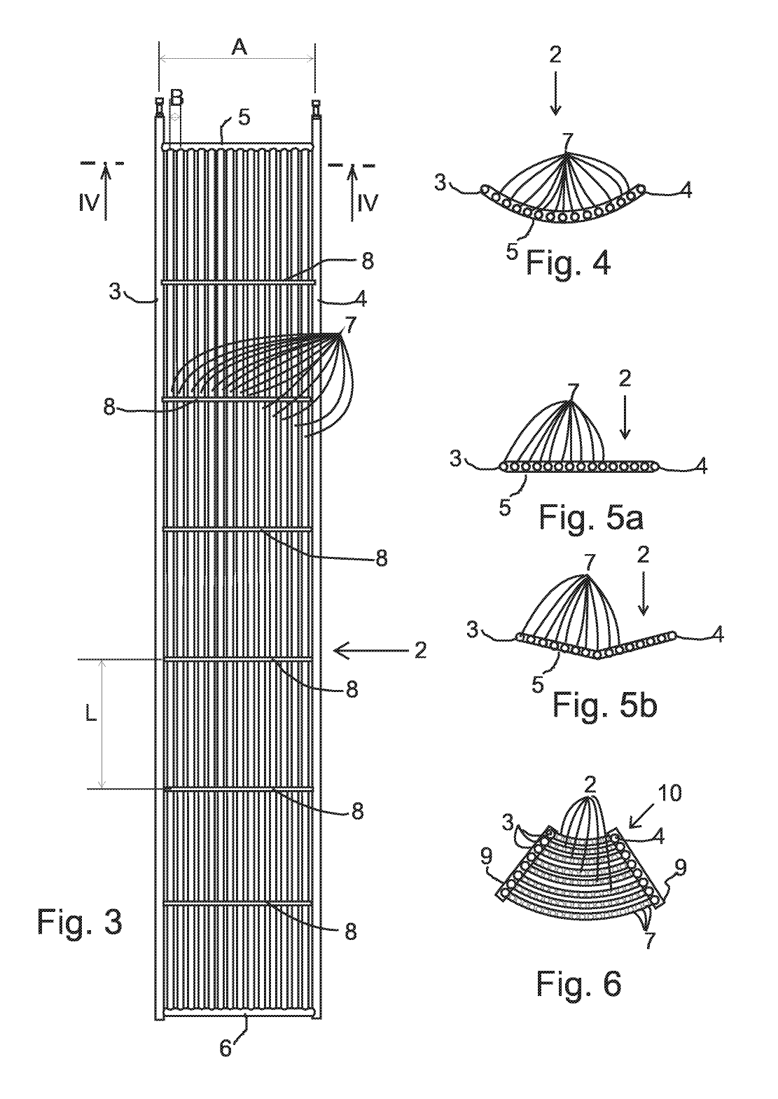

FIGS. 3 and 4 show one of the heating elements 2. The heating element 2 includes a pair of straight first longitudinal pipes 3 and 4 supported in parallel to each other at a distance A from each other. The first longitudinal pipes 3 and 4 extend in the longitudinal direction of the drum 1.

Furthermore, the heating element 2 includes a pair of curved end pipes 5, 6 extending substantially transversely relative to the first longitudinal pipes 3, 4 in the vicinity of the ends of the first longitudinal pipes. The curved end pipes 5, 6 connect the first longitudinal pipes 3 and 4 rigidly to each other. The radius of curvature of the end pipes 5, 6 determines the curvature of the element. The first longitudinal pipes 3 and 4 are provided in flow connection to each other through the end pipes 5 and 6 so that the steam and condensate are able to flow within the heating element 2.

The heating element 2 includes a set of straight second longitudinal pipes 7 provided adjacently in parallel to the first longitudinal pipes 3, 4. The second longitudinal pipes 7 are fastened by each end to the end pipes 5, 6 so that each two adjacent second longitudinal pipes are disposed at a distance B from each other and the second longitudinal pipes 7 are provided in flow connection with the end pipes 5, 6. In addition, the heating element 2 includes a set of curved stiffening members 8 arranged to extend transversely relative to the first and the second longitudinal pipes and fastened at a distance L from each other along the length of the heating element.

FIG. 5a presents an embodiment corresponding to FIG. 4 where the end pipes 5 and 6 (not shown) are straight. FIG. 5b presents an embodiment corresponding to FIG. 4 where the end pipes 5 and 6 (not shown) are V-shaped.

FIG. 6 further presents one embodiment where a plurality of heating elements 2 of different sizes according to FIG. 4 are provided on a support structure 9 binding the heating elements 2 to each other to form a self-supporting package 10. The self-supporting package 10 may contain two or more heating elements 2. A similar package 10 can also be formed from the heating elements according to FIG. 5a or FIG. 5b.

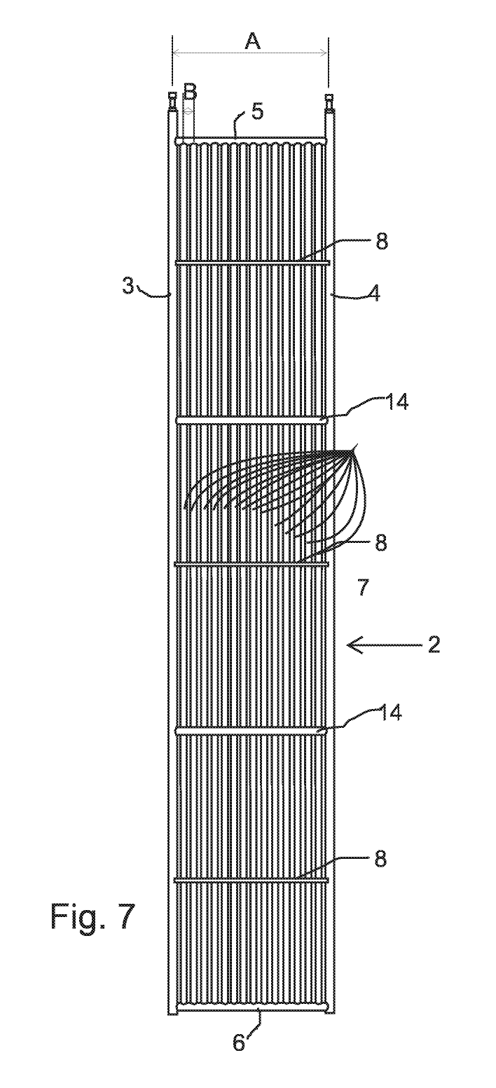

FIG. 7 presents yet one embodiment of the heating element 2 that may be as shown in FIG. 3 and 4 or 3 and 5a or 5b. A difference to the embodiment described above is that in the embodiment of FIG. 7 the heating element 2 may include, in parallel to the end pipes 5 and 6, intermediate pipes 14 extending substantially transversely relative to the first longitudinal pipes 3, 4. The end pipes 5, 6, the stiffening members 8 and the optional intermediate pipes 14 connect the first longitudinal pipes 3 and 4 rigidly to each other. The first longitudinal pipes 3 and 4 are provided in flow connection to each other through the end pipes 5 and 6 and the intermediate pipes 14 so that the steam and condensate are able to flow within the heating element 2.

The invention is not limited merely to the examples of its embodiments referred to above; instead, many variations are possible within the scope of the inventive idea defined by the claims.

1. A steam drier including a rotatable elongated drum and a set of heating elements provided in the interior space within the drum and supported on the drum in order to rotate along with the drum, each heating element including
a pair of straight first longitudinal pipes supported in parallel to each other at a distance from each other, the first longitudinal pipes extending in the longitudinal direction of the drum, and
a pair of end pipes extending substantially transversely relative to the first longitudinal pipes in the vicinity of the ends of the first longitudinal pipes, wherein the end pipes connect the first longitudinal pipes rigidly to each other so that the first longitudinal pipes are provided in flow connection to each other through the end pipes in order to allow the flow of steam within the heating element, wherein the heating element includes a set of straight second longitudinal pipes provided in parallel to the first longitudinal pipes, the second longitudinal pipes being fastened by each end to the end pipes so that each two adjacent second longitudinal pipes are disposed at a distance from each other and the second longitudinal pipes are provided in flow connection with the end pipes.

2. The steam drier according to claim 1, wherein the heating element includes a set of stiffening members arranged to extend transversely relative to the first and the second longitudinal pipes and fastened at a distance from each other along the length of the heating element.

3. The steam drier according to claim 1, wherein a set of two or more heating elements is provided on a support structure adapted to bind said heating elements to each other to form a self-supporting package.

4. The steam drier according claim 1, wherein the heating element includes, in parallel to the end pipes and, intermediate pipes extending substantially transversely relative to the first longitudinal pipes, the intermediate pipes being fastened by the ends to the first longitudinal pipes so that the first longitudinal pipes are provided in flow connection to each other through the intermediate pipes.

5. The steam drier according to claim 1, wherein the end pipes are curved.

6. The steam drier according to claim 1, wherein the end pipes are straight.

7. The steam drier according to claim 1, wherein the end pipes are V-shaped.
